(19) United States
(12) Patent Application Publication
(10) Pub. No.: US 2026/0188055 A1
(43) Pub. Date: Jul. 2, 2026

(54) WARNING INDICATOR SEVERITY DIAGNOSIS AND ALERT SYSTEM, METHOD, AND COMMUNICATION PROTOCOL

(71) Applicant: Volvo Car Corporation, Göteborg (SE)

(72) Inventors: Giovanni Spiritoso, Göteborg (SE); Boyd Stowe, Ridgeville, SC (US); Jessica Areizaga, Ridgeville, SC (US); Charles Leonardi, Ridgeville, SC (US)

(21) Appl. No.: 19/006,349

(22) Filed: Dec. 31, 2024

(51) Int. Cl. G07C 5/00; G07C 5/02

(52) U.S. Cl. CPC G07C 5/006; G07C 5/008; G07C 5/02

(57) ABSTRACT

A system, method, and communication protocol for providing warning indicator severity diagnoses and alerts. The system captures data associated with operations of the vehicle using the plurality of system sensors. The system further detects a service trigger event based on the data that is captured. The system further identifies one or more vehicle components associated with the service trigger event. The system further estimates one or more severity levels of the service trigger event based on the one or more vehicle components that are identified. The system further transmits one or more service alerts to one or more target recipients based on the one or more severity levels for each vehicle component of the one or more vehicle components that is identified in response to at least one severity level of the one or more severity levels meeting a predetermined severity threshold.

### INTRODUCTION

The present disclosure relates generally to the automotive field. When there is a problem with a vehicle, a low tire pressure light, check engine light, or other warning indicator comes on during a trip. A driver becomes aware that a problem exists, but the driver does not typically know how serious the problem is and if driving can continue or should stop immediately. The driver typically brings the vehicle into a service center or garage to diagnose the problem in order to take appropriate corrective action, without the service center or garage having prior information about the problem.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a system, method, and communication protocol for providing warning indicator severity diagnoses and alerts. In one illustrative embodiment, the present disclosure provides a system including, a plurality of system sensors coupled to a vehicle, one or more processors, and logic encoded in one or more non-transitory computer-readable storage media for execution by the one or more processors. The logic when executed is operable to cause the one or more processors to perform operations including: capturing data associated with operations of the vehicle using the plurality of system sensors; detecting a service trigger event based on the data that is captured; identifying one or more vehicle components associated with the service trigger event; estimating one or more severity levels of the service trigger event based on the one or more vehicle components that are identified; and transmitting one or more service alerts to one or more target recipients based on the one or more severity levels for each vehicle component of the one or more vehicle components that is identified in response to at least one severity level of the one or more severity levels meeting a predetermined severity threshold. Optionally, in some embodiments, the data is associated with operations includes tire data. In some embodiments, the data is associated with operations includes engine data. In some embodiments, the logic when executed is further operable to cause the one or more processors to perform operations including modifying the one or more service alerts for each target recipient of the one or more target recipients based on one or more alert policies. In some embodiments, at least one service alert of the one or more service alerts is transmitted to a driver of the vehicle, where the at least one service alert indicates the service trigger event, at least one vehicle component associated with the service trigger event, and a recommendation. In some embodiments, at least one service alert of the one or more service alerts is transmitted to at least one service entity, where the service alert indicates the service trigger event, at least one vehicle component associated with the service trigger event, and a service request. In some embodiments, at least one service alert of the one or more service alerts is transmitted to at least one third-party entity, where the least one third-party entity alerts other drivers of any hazardous conditions associated with the vehicle.

In another illustrative embodiment, the present disclosure provides a non-transitory computer-readable storage medium with program instructions stored thereon. The program instructions when executed by one or more processors are operable to cause the one or more processors to perform operations including: capturing data associated with operations of the vehicle using the plurality of system sensors; detecting a service trigger event based on the data that is captured; identifying one or more vehicle components associated with the service trigger event; estimating one or more severity levels of the service trigger event based on the one or more vehicle components that are identified; and transmitting one or more service alerts to one or more target recipients based on the one or more severity levels for each vehicle component of the one or more vehicle components that is identified in response to at least one severity level of the one or more severity levels meeting a predetermined severity threshold. Optionally, in some embodiments, the data is associated with operations includes tire data. In some embodiments, the data is associated with operations includes engine data. In some embodiments, the instructions when executed are further operable to cause the one or more processors to perform operations including modifying the one or more service alerts for each target recipient of the one or more target recipients based on one or more alert policies. In some embodiments, at least one service alert of the one or more service alerts is transmitted to a driver of the vehicle, where the at least one service alert indicates the service trigger event, at least one vehicle component associated with the service trigger event, and a recommendation. In some embodiments, at least one service alert of the one or more service alerts is transmitted to at least one service entity, where the service alert indicates the service trigger event, at least one vehicle component associated with the service trigger event, and a service request. In some embodiments, at least one service alert of the one or more service alerts is transmitted to at least one third-party entity, where the least one third-party entity alerts other drivers of any hazardous conditions associated with the vehicle.

In a further illustrative embodiment, the present disclosure provides a computer-implemented method for providing warning indicator severity diagnoses and alerts, the method including: capturing data associated with operations of the vehicle using the plurality of system sensors; detecting a service trigger event based on the data that is captured; identifying one or more vehicle components associated with the service trigger event; estimating one or more severity levels of the service trigger event based on the one or more vehicle components that are identified; and transmitting one or more service alerts to one or more target recipients based on the one or more severity levels for each vehicle component of the one or more vehicle components that is identified in response to at least one severity level of the one or more severity levels meeting a predetermined severity threshold. Optionally, in some embodiments, the data is associated with operations includes tire data. In some embodiments, the data is associated with operations includes engine data. In some embodiments, the method further includes modifying the one or more service alerts for each target recipient of the one or more target recipients based on one or more alert policies. In some embodiments, at least one service alert of the one or more service alerts is transmitted to a driver of the vehicle, where the at least one service alert indicates the service trigger event, at least one vehicle component associated with the service trigger event, and a recommendation. In some embodiments, at least one service alert of the one or more service alerts is transmitted to at least one service entity, where the service alert indicates the service trigger event, at least one vehicle component associated with the service trigger event, and a service request.

### BRIEF DESCRIPTION OF THE DRAWINGS

The present disclosure is illustrated and described with reference to the various drawings, in which like reference numbers are used to denote like system components and/or method steps, as appropriate.

FIG. 1 is a block diagram of an example environment for providing warning indicator severity diagnoses and alerts.

FIG. 2 is a flow chart for providing warning indicator severity diagnoses and alerts.

FIG. 3 is a block diagram of an environment, showing a view of a dashboard of a vehicle.

FIG. 4 is a block diagram of an example high-level architecture for providing warning indicator severity diagnoses and alerts.

FIG. 5 is a block diagram of an example network environment of the present disclosure.

FIG. 6 is a block diagram of an example computing system of the present disclosure.

### DETAILED DESCRIPTION

A system, method, and communication protocol are described for providing warning indicator severity diagnoses and alerts. As described in more detail, the system captures data associated with operations of a vehicle using multiple system sensors. The system further detects a service trigger event based on the data that is captured. The system further identifies one or more vehicle components associated with the service trigger event. The system further estimates one or more severity levels of the service trigger event based on the one or more vehicle components that are identified and their current state. The system further transmits one or more service alerts to one or more target recipients based on the one or more severity levels for each vehicle component of the one or more vehicle components that are identified in response to at least one severity level of the one or more severity levels meeting a predetermined severity threshold.

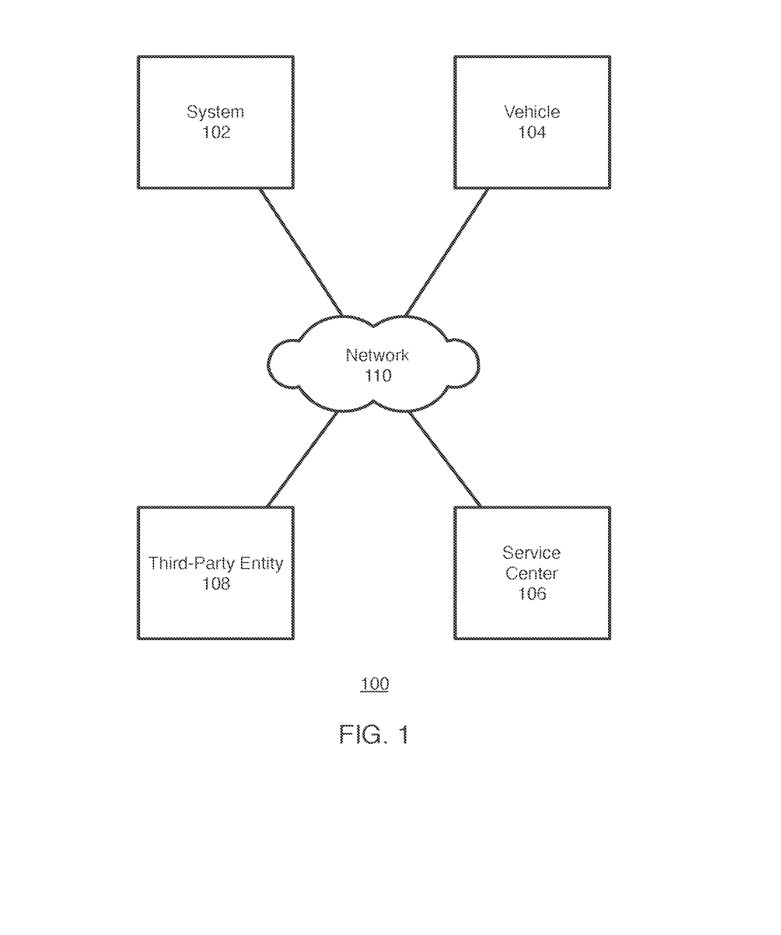

FIG. 1 is a block diagram of an example environment 100 for providing warning indicator severity diagnoses and alerts. Shown are blocks that represent a system 102, a vehicle 104, a service center 106, a third-party entity 108, and a network 110. As described in more detail, when the system 102 alerts the driver of the vehicle 104 with a warning indicator, the system 102 displays sufficient details to inform the driver of the nature of the problem (e.g., low oil, low tire pressure, engine malfunction, transmission malfunction, brake malfunction, battery compromise, etc.) and to inform the driver of the severity diagnoses of the problem (e.g., dangerously low oil level, slow leak in a tire, fast leak in the tire, system malfunction that may compromise continued operation, system malfunction that may jeopardize safety, battery damage, etc.). Further example embodiments directed to alerts are described in more detail below. As used, the driver of the vehicle broadly refers to an operator of or occupant in the vehicle, which may also include a passenger.

The system may also alert a service entity, such as service center 106 or tow operator, of the problem if needed for repairs. If the vehicle 104 needs to be serviced, the system 102 may make an appointment with the service center 104 so that the service center is ready for the vehicle 104 upon arrival and is fully apprised of the service that is needed. The service center may also order parts in advance as needed. In various embodiments, the service center may be a service center associated with the make of the vehicle, such as dealer service center, an automobile repair shop known to the driver, or a local automobile repair shop in proximity to the vehicle 104 in case of needed emergency repairs. Further example embodiments directed to the service center are described in more detail below.

The system may also alert a third-party entity 108 of the problem. The third-party entity 108 may be a traffic control center, for example. If the severity of the problem is severe enough to cause the vehicle 104 to be a potential hazard to other vehicles driving in proximity to the vehicle 104, the third-party entity 108 may alert the relevant vehicles and drivers in in proximity to the vehicle 104 in order to prevent collisions. Further example embodiments directed to third-party entities are described in more detail below.

In various embodiments, the vehicle 104 includes a variety of system sensors coupled to the vehicle 104, such system sensors enabling the system 102 and the vehicle 104 to monitor various aspects of the vehicle 104 (e.g., engine aspects including mechanical and electrical systems, tire aspects, transmission aspects, brake aspects, battery aspects, etc.). The particular system sensors may vary, depending on the particular implementation. Example system sensors may include standard engine and vehicle sensors, including oxygen sensors, vibration sensors, special sensors for particular vehicle components (e.g., tire pressure sensors, etc.), transmission sensors, battery sensors, etc.

The system 102 may communicate with the vehicle 104, the service center 106, and the third-party entity 108 directly or via a network 110. The network 108 may be any suitable communication network such as a near-field network, a Wi-Fi network, a cloud network, the Internet, etc.

For ease of illustration, FIG. 1 shows one block for each of the system 102, the vehicle 104, the service center 106, the third-party entity 108, and the network 110. Blocks 102, 104, 106, 108, and 110 may each represent multiple systems, vehicles (e.g., one vehicle towing another vehicle), services centers, third-party entities, or networks. In other embodiments, the environment 100 may not have all of the components shown and/or may have other elements including other types of elements instead of, or in addition to, those shown.

While system 102 performs embodiments described, in other embodiments, any suitable component or combination of components associated with the system 102 or any suitable processor or processors associated with system 102 may facilitate performing the embodiments described.

While the system 102 is shown in the example embodiment of FIG. 1 as being separate from the vehicle 104, in various embodiments, the system 102 may also be on board or integrated with the vehicle 104.

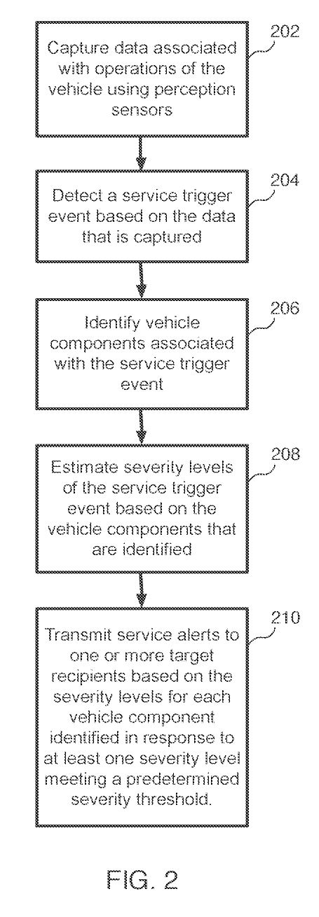

FIG. 2 is a flow chart for providing warning indicator severity diagnoses and alerts. Referring to both FIGS. 1 and 2, a method is initiated at block 202, where a system such as the system 102 captures data associated with operations of the vehicle using system sensors. As indicated above, example system sensors may include standard engine and vehicle sensors, including oxygen sensors, vibration sensors, special sensors for particular vehicle components (e.g., tire pressure sensors, etc.), transmission sensors, battery sensors, etc.

In various embodiments, the data may be associated with operations related to tire data. For example, the tire data may include tire pressure, tire balance, etc. In various embodiments, the data may be associated with operations related to engine data. For example, the engine data may include combustion data, timing data, transmission data, etc. The engine data may also include service trigger signals for each engine system and/or each engine component. Other example systems that may be monitored include brake systems, battery systems, safety systems, environmental control systems, vehicle convenience systems, etc.

At block 204, the system 102 detects a service trigger event based on the data that is captured. In various embodiments, there may be different service trigger events associated with different vehicle systems and different vehicle components. For example, if a front right tire has a slow leak, a service trigger event may arise if the tire pressure drops below a predetermined severity threshold. In another example, a service trigger event may arise if the vibration level of a given engine component exceeds a predetermined severity threshold. In a further example, a service trigger event may arise if an unexpected battery discharge or overheating condition is detected.

At block 206, the system 102 identifies one or more vehicle components associated with the service trigger event. In the examples above, the system may identify a particular tire (e.g., front right tire, etc.) or a particular engine component (e.g., the head gasket, the transmission, etc.).

At block 208, the system 102 estimates one or more severity levels of the service trigger event based on the vehicle components that are identified. In various embodiments, there may be multiple severity levels for each vehicle component. Embodiments directed to different multiple severity levels are described in more detail herein.

At block 210, the system 102 transmits one or more service alerts to one or more target recipients based on the severity levels for each vehicle component that is identified in response to at least one severity level meeting a predetermined severity threshold. Example embodiments directed to alerts transmitted to various types of recipients are described in more detail herein.

Although the steps, operations, or computations may be presented in a specific order, the order may be changed in particular embodiments. Other orderings of the steps are possible, depending on the particular implementation. In some particular embodiments, multiple steps shown as sequential in this specification may be performed at the same time. Also, some embodiments may not have all of the steps shown and/or may have other steps instead of, or in addition to, those shown herein.

In various embodiments, the system tailors or modifies one or more of the service alerts for each target recipient based on one or more alert policies. In various embodiments, the system may transmit at least one service alert to the driver of the vehicle, where the service alert indicates the service trigger event, a severity level, at least one vehicle component associated with the service trigger event, and a recommendation. The following are example alert policies according to various embodiments.

If the problem for a particular vehicle component meets a first or low predetermined severity threshold, the system may deem it a service trigger event and send an alert to the vehicle 104 to alert the driver. This alert may indicate a low severity level or non-urgent event.

If the problem for the same vehicle component meets a second or higher predetermined severity threshold, the system may deem it a service trigger event and deem the situation an urgent or hazardous event. As such, the system may send an alert to the vehicle 104 to alert the driver. This alert may indicate a high severity level or hazardous event.

The recommendation may vary depending on the particular implementation. For example, the system may recommend a timing recommendation as to whether the driver should take immediate action (e.g., problems meeting high predetermined severity thresholds) or may wait until a convention time to address any problems (e.g., problems meeting low predetermined severity thresholds). If the system recommends pulling over or driving to safe spot to stop, the system may provide directions to the driver to the safe spot to stop. The system may also indicate to the driver whether the driver can continue driving, how long or how far the driver can continue driving, if the driver can make it to the end of the route if the destination is programmed into the system, if the driver should stop immediately, etc. In an autonomous operation mode, the system may operate the vehicle in accordance with the alert severity indication, allowing pre-planned operation to continue or driving the vehicle to an immediate stop or service location.

In various embodiments, the system may transmit at least one service alert to at least one service entity such as service center 106, where the service alert indicates the service trigger event, at least one vehicle component associated with the service trigger event, and a service request. For example, in various embodiments, the system may establish communication with the service center 106, make an appointment, provide an estimated time of arrival, provide information for the service center 106 to have parts ready or to order parts if needed, etc.

In various embodiments, the system may prioritize a problem based on the component and the severity level of the problem. For example, one vehicle component (e.g., a particular tire) may be prioritized over another vehicle component (e.g., tail lights) for service work. Based on the urgency of the problem, the system may provide options for the service center 106. The system may also recommend a service center within a recommended travel distance.

In various embodiments, the system may transmit at least one service alert to at least one third-party entity, where the least one third-party entity alerts other drivers of any hazardous conditions associated with the vehicle. For example, the third-party entity 108 may alert surrounding vehicles in proximity to the vehicle 104. In various embodiments, the alert to the third-party entity may be tailored or modified to more thoroughly inform the third-party entity. For example, the system may include any information that will assist the third-party entity in making the area around the vehicle 104 safe. For example, such information may include vehicle identification (e.g., VIN) of the vehicle 104, the type of the vehicle 104, the location of the vehicle 104, the direction of the vehicle 104, the problem (e.g., engine crack, failing breaks, failing tire, etc.), the degree of severity, etc. Such information may be utilized by the third-party entity to control traffic signals as needed (e.g., temporary stopping cross traffic with appropriate red lights, slowing down any or all traffic with appropriate flashing yellow lights, etc.). In this respect, communication may be vehicle-to-driver (V2D), vehicle-to-vehicle (V2V), vehicle-to-network (V2N), and/or vehicle-to-infrastructure (V2I).

In various embodiments, the system may enable the service center 106 to communicate with the vehicle 106 or driver of the vehicle. For example, communication from the service center 106 to the vehicle 104 may include associated confirmations for bringing the vehicle 104 in. The system may enable other third-party entities such as roadside assistance, tow truck companies, etc. to communicate with the driver via the vehicle 104. Such communications may be AI based. In some embodiments, the system may generate a route to a given service center or station, and the route may be selected to avoid damaging the vehicle 104 or further damaging the vehicle 104 based on a system calculation regarding safe travel distance remaining, degree of severity, etc.

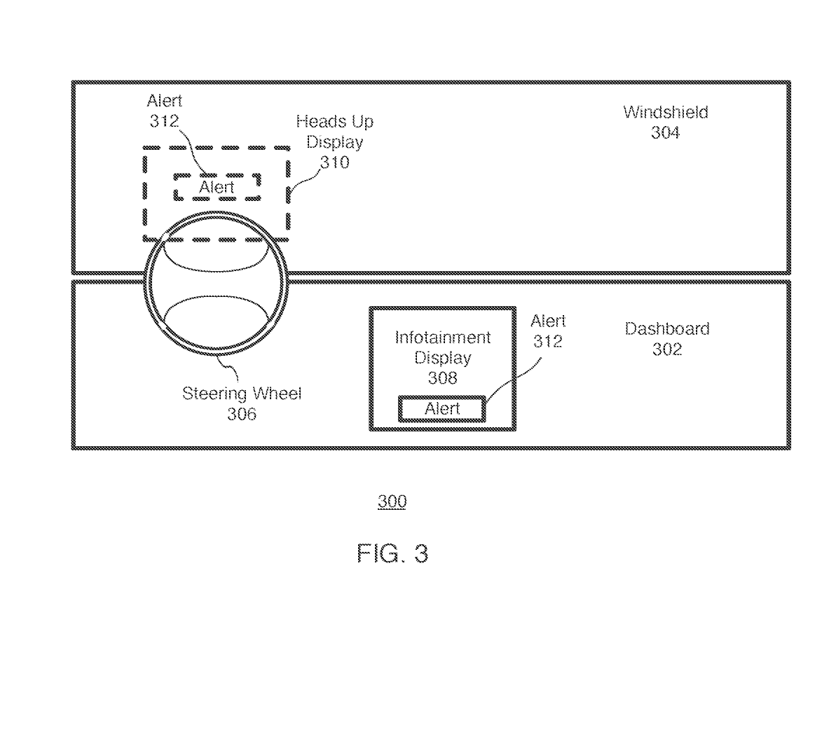

FIG. 3 is a block diagram of an environment, showing a view of a dashboard of a vehicle. This portion of the vehicle shown may be that of the vehicle 104 shown in FIG. 1. Shown is a dashboard 302, a windshield 304, a steering wheel 306, an infotainment display 308, a heads up display 310, and an alert 312.

The system may cause the alert 312 to be displayed in the infotainment display 308 and/or in the heads up display 310. In various embodiments, the system may select whether to display the alert 312 in each of the infotainment display 308 and the heads up display 301 independently and based on the severity of the alert 312. For example, in some embodiments, if the severity is small or not deemed to be currently hazardous (e.g., low oil, slow tire leak, bad battery cell, etc.), the system may display the alert only in the infotainment display 308 if not both the infotainment display 308 and in the heads up display 310. In such scenarios, there is less urgency for the driver to take immediate action.

In some embodiments, if the severity is large or deemed to be currently hazardous (e.g., almost empty oil, fast tire leak, failing brakes, inoperative airbags, bad battery pack, etc.), the system may display the alert only in the heads up display 310 if not both the infotainment display 308 and in the heads up display 301. In such scenarios, there is more urgency for the driver to take immediate action. The heads up display 310 provides greater visibility for the driver to see the alert faster or immediately. In some embodiments, if the system computes that the severity high or hazardous, the system may alter the alert 312 to be more noticeable. For example, the system may cause the alert to flash, change colors, display larger, etc. This may be a scenario, for example, where the tire pressure of a given tire dropped below a predetermined safety threshold, where the tire may fail. Modes of driver alerts may include visual, audible, haptic, driver assist, autonomous driving, etc.

In some embodiments, and in high-severity scenarios, the system may implement automatic safety actions, such as automatically breaking to slow down, or pull over to the side of the road and halt the vehicle in the case of autonomous vehicles. The system may also take control of the steering of the vehicle to automatically drive to safe spot and park. The system may also cause the hazard lights of the vehicle 114 to flash or other warnings to be deployed to surrounding operators.

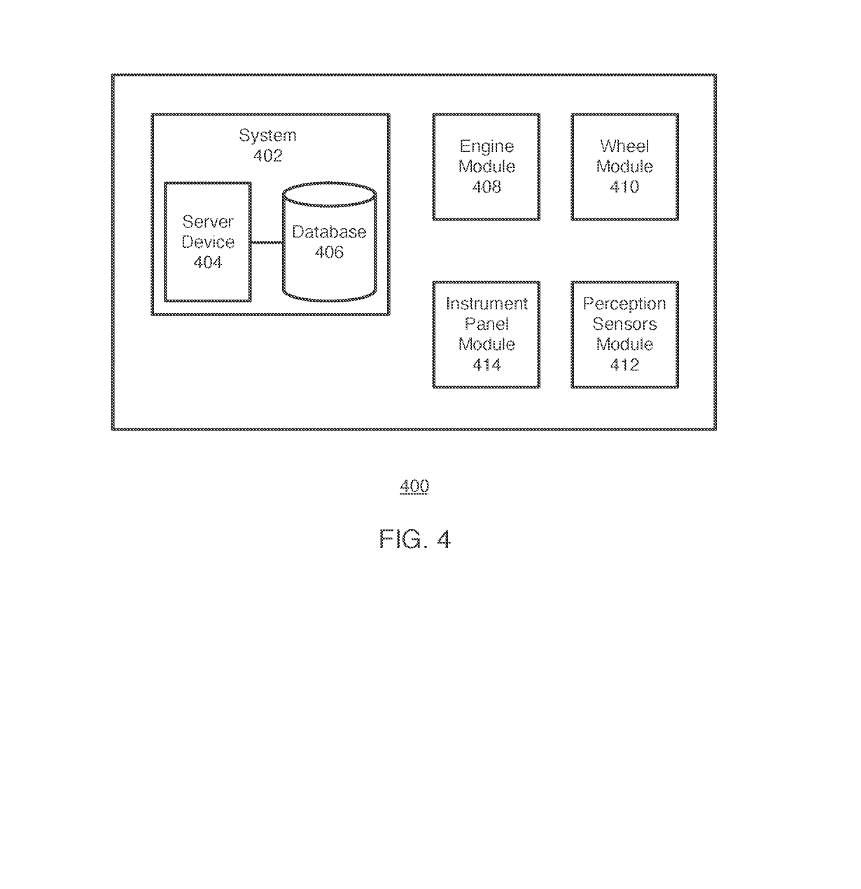

FIG. 4 is a block diagram of an example high-level architecture 400 for providing warning indicator severity diagnoses and alerts. Shown is a system 402, which may be used to implement the system 102 of FIG. 1. The system 402 includes a server device 404 and a database 406. Also shown is an engine module 408, a wheel module 410, a system sensors module 412, and an instrument panel module 414. The engine module 408, a wheel module 410, a system sensors module 412, and an instrument panel module 414 may be implemented using a combination of hardware and software. In various embodiments, the software may include and execute any suitable AI model, including any AI, machine learning, and computer vision techniques to track the performance of various components of the vehicle, including the engine and any associated systems, the wheels and any associated systems, etc. The system may utilize the AI model to detect any problems with the vehicle 104 and to perform any needed actions such a sending out one or more alerts, taking any automatic safety actions of the vehicle, etc., and thereby maximize safety associated with the vehicle 104 as described herein. Such AI model may be pre-trained and may be re-trained via feedback from the operation of the system 102 in the vehicle 104 and the operation of other systems in other vehicles.

The system 402 communicates data signals and control signals with the engine module 408, the wheel module 410, the system sensors module 412, and the instrument panel module 414 via the server device 404. The database 406 may be used to store various types of information such as components of the vehicle 104, associated service triggers for each component, predetermined severity thresholds for each component, actions associated with particular vehicle components and associated with particular severity thresholds and levels for each component, corrective actions associated with each component, information in alerts to the vehicle 104 and driver, to the service center 106, to the third-party entity 108, etc., as well as AI training information, for example.

The system enables the engine module 408 to monitor and track the performance of systems and components associated with the engine of the vehicle. The system also enables the wheel module 410 to monitor and track the systems and components associated with the wheels of the vehicle. The system also enables the system sensors module 412 to control the system sensors. The system also enables the instrument panel module 414 to control information displayed on the instrument panel and to enable the driver to interact with the infotainment display or system of the instrument panel.

Embodiments described herein have numerous benefits. For example, embodiments provide a driver with not only a check engine alert, but also indicate the vehicle system or vehicle component that is experiencing a problem. Embodiments also provide the level of severity or urgency. Embodiments also provide recommendations. Embodiments also provide alerts to other entities such as service centers for providing service to the vehicle and/or third-party entities for alerting other drivers of any potent hazards associated with the vehicle having a problem.

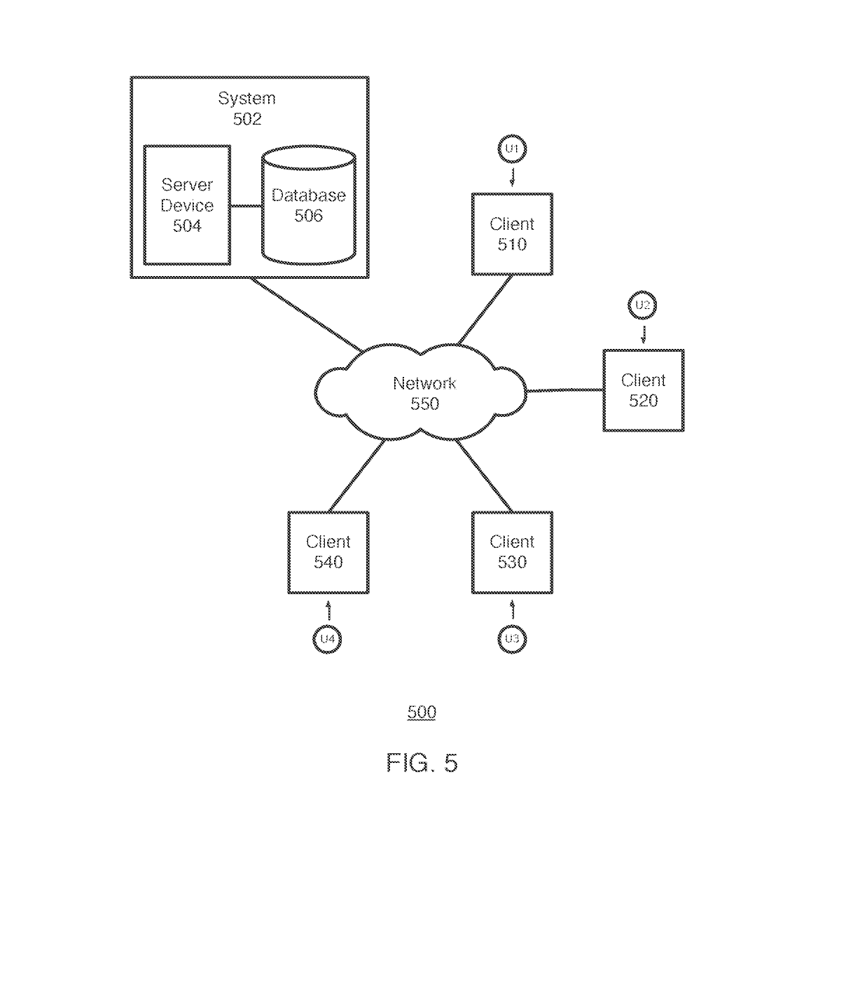

FIG. 5 is a block diagram of an example network environment 500 of the present disclosure. In some embodiments, network environment 500 includes a system 502, which includes a server device 504 and a database 506. In various embodiments, the system 502 may be used to implement the system 102 of FIG. 1, as well as to perform embodiments described herein. The network environment 500 also includes the client devices 510, 520, 530, and 540, which may communicate with the system 502 and/or may communicate with each other directly or via the system 502. The network environment 500 also includes a network 550 through which the system 502 and the client devices 510, 520, 530, and 540 communicate. The network 550 may be any suitable communication network such as a Wi-Fi network, Bluetooth network, wide area network (WAN), local area network (LAN), the Internet, etc.

In various embodiments, the client devices 510, 520, 530, and 540 may be used to implement devices associated with the vehicle 104, one or more service centers, one or more third-party entities, etc.

For ease of illustration, FIG. 5 shows one block for each of the system 502, server device 504, and the network database 506, and shows four blocks for the client devices 510, 520, 530, and 540. The blocks 502, 504, and 506 may represent multiple systems, server devices, and network databases. Also, there may be any number of client devices. In other embodiments, the environment 500 may not have all of the components shown and/or may have other elements including other types of elements instead of, or in addition to, those shown herein.

While the server device 504 of the system 502 performs embodiments described herein, in other embodiments, any suitable component or combination of components associated with the system 502 or any suitable processor or processors associated with the system 502 may facilitate performing the embodiments described herein.

In the various embodiments described herein, a processor of the system 502 and/or a processor of any the client device 510, 520, 530, and 540 cause the elements described herein (e.g., information, etc.) to be displayed in a user interface on one or more display screens.

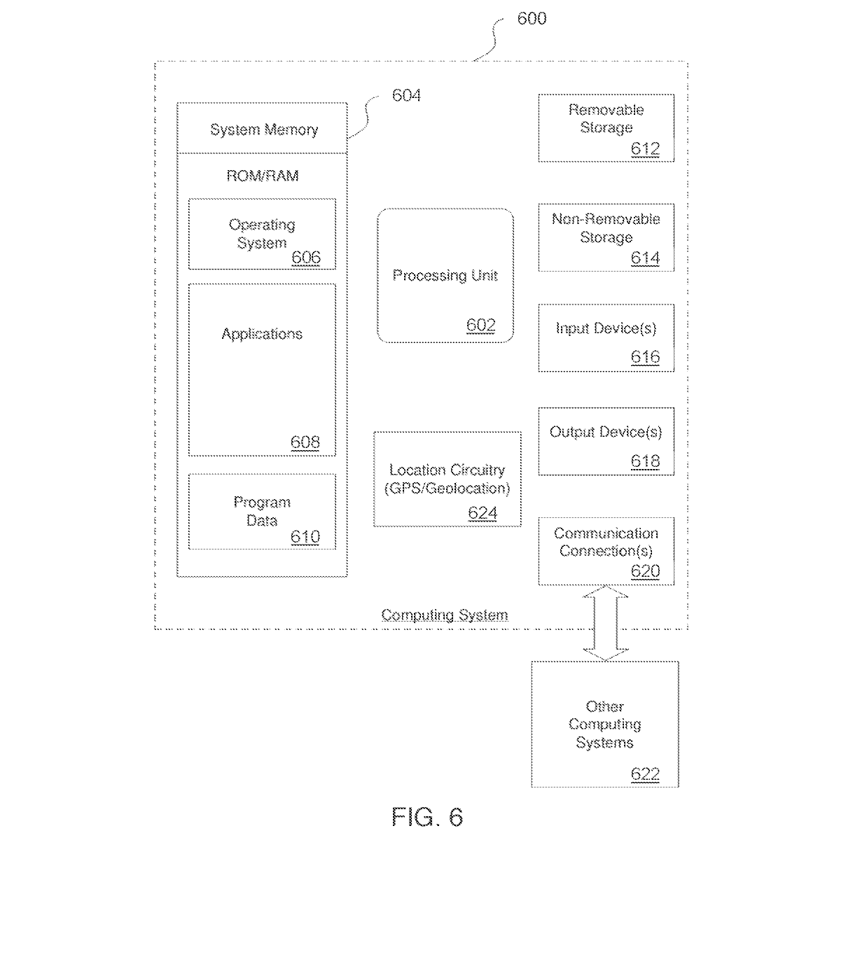

FIG. 6 is a block diagram of an example computing system 600 of the present disclosure. The computing system 600 may be used to implement the system 102 of FIG. 1 and/or the server system 502 of FIG. 5, as well as to perform embodiments described herein. The computing system 600 typically includes at least one processing unit 602 and a system memory 604. Depending on the particular configuration and type of computing device, the system memory 604 may be volatile such as random-access memory (RAM), non-volatile such as read-only memory (ROM), flash memory, and the like, or some combination of volatile memory and non-volatile memory. The system memory 604 typically maintains an operating system 606, one or more applications 608, and program data 610. The operating system 606 may include any number of operating systems executable on desktops or portable devices including, but not limited to, Linux, Microsoft Windows®, Apple OS®, or Android®.

The computing system 600 may also have additional features or functionality. For example, the computing system 600 may also include additional data storage devices (removable and/or non-removable) such as, for example, magnetic disks, optical disks, tape, or flash memory. Such additional storage may include a removable storage 612 and a non-removable storage 614. Computer storage media may include volatile and non-volatile, removable and non-removable media implemented in any method or technology for storage of information, such as computer-readable instructions, data structures, program modules or other data. The system memory 604, the removable storage 612, and the non-removable storage 614 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 600. Any such computer storage media may be part of the computing system 600.

The computing system 600 may also have input device(s) 616 such as a keyboard, mouse, pen, voice input device, touchscreen input device, etc. Output device(s) 618 such as a display, speakers, printer, short-range transceivers such as a Bluetooth transceiver, etc., may also be included. The computing system 600 also may include one or more communication connections 620 that allow the computing system 600 to communicate with other computing systems 622, such as over a wired or wireless network or via Bluetooth (a Bluetooth transceiver may be regarded as an input/output device and a communications connection). The one or more communication connections 620 are an example of communication media. Available forms of communication media typically carry computer-readable instructions, data structures, program modules or other data in a modulated data signal such as a carrier wave or other transport mechanism and include any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

The computing system 600 may also include location circuitry 624. In various embodiments, the location circuitry 624 may include circuitry including global positioning system (GPS) circuitry and/or geolocation circuitry. The location circuitry 624 may automatically discern its location based on relative positions to multiple GPS satellites and/or triangulation using cellular carrier network(s) and/or IEEE Standard 802.11 wireless (Wi-Fi) networks (collectively referred to as “geolocation services”) to determine location based on multiple cellular communications facilities and/or multiple Wi-Fi networks. The location circuitry 624, including GPS circuitry and/or geolocation circuitry, is frequently incorporated in smartphones and many other tablets or other portable devices. In various embodiments, computing system 600 may not have all of the components shown and/or may have other elements including other types of components instead of, or in addition to, those shown herein.

Although the present disclosure is illustrated and described with reference to illustrative embodiments and specific examples provided, it will be readily apparent to those of ordinary skill in the art that other embodiments and examples may perform similar functions and/or achieve like results. All such equivalent embodiments and examples are within the spirit and scope of the present disclosure and are intended to be covered by the following non-limiting claims for all purposes.

What is claimed is:

1. A system comprising:
a plurality of system sensors coupled to a vehicle;
one or more processors; and
logic encoded in one or more non-transitory computer-readable storage media for execution by the one or more processors and when executed operable to cause the one or more processors to perform operations comprising:
capturing data associated with operations of the vehicle using the plurality of system sensors;
detecting a service trigger event based on the data that is captured;
identifying one or more vehicle components associated with the service trigger event;
estimating one or more severity levels of the service trigger event based on the one or more vehicle components that are identified; and
transmitting one or more service alerts to one or more target recipients based on the one or more severity levels for each vehicle component of the one or more vehicle components that is identified in response to at least one severity level of the one or more severity levels meeting a predetermined severity threshold.

2. The system of claim 1, wherein the data is associated with operations comprises tire data.

3. The system of claim 1, wherein the data is associated with operations comprises engine data.

4. The system of claim 1, wherein the logic when executed is further operable to cause the one or more processors to perform operations comprising modifying the one or more service alerts for each target recipient of the one or more target recipients based on one or more alert policies.

5. The system of claim 1, wherein at least one service alert of the one or more service alerts is transmitted to a driver of the vehicle, and wherein the at least one service alert indicates the service trigger event, at least one vehicle component associated with the service trigger event, and a recommendation.

6. The system of claim 1, wherein at least one service alert of the one or more service alerts is transmitted to at least one service entity, and wherein the service alert indicates the service trigger event, at least one vehicle component associated with the service trigger event, and a service request.

7. The system of claim 1, wherein at least one service alert of the one or more service alerts is transmitted to at least one third-party entity, and wherein the least one third-party entity alerts other drivers of any hazardous conditions associated with the vehicle.

8. A non-transitory computer-readable storage medium with program instructions stored thereon, the program instructions when executed by one or more processors are operable to cause the one or more processors to perform operations comprising:
capturing data associated with operations of the vehicle using a plurality of system sensors;
detecting a service trigger event based on the data that is captured;
identifying one or more vehicle components associated with the service trigger event;
estimating one or more severity levels of the service trigger event based on the one or more vehicle components that are identified; and
transmitting one or more service alerts to one or more target recipients based on the one or more severity levels for each vehicle component of the one or more vehicle components that is identified in response to at least one severity level of the one or more severity levels meeting a predetermined severity threshold.

9. The computer-readable storage medium of claim 8, wherein the data is associated with operations comprises tire data.

10. The computer-readable storage medium of claim 8, wherein the data is associated with operations comprises engine data.

11. The computer-readable storage medium of claim 8, wherein the instructions when executed are further operable to cause the one or more processors to perform operations comprising modifying the one or more service alerts for each target recipient of the one or more target recipients based on one or more alert policies.

12. The computer-readable storage medium of claim 8, wherein at least one service alert of the one or more service alerts is transmitted to a driver of the vehicle, and wherein the at least one service alert indicates the service trigger event, at least one vehicle component associated with the service trigger event, and a recommendation.

13. The computer-readable storage medium of claim 8, wherein at least one service alert of the one or more service alerts is transmitted to at least one service entity, and wherein the service alert indicates the service trigger event, at least one vehicle component associated with the service trigger event, and a service request.

14. The computer-readable storage medium of claim 8, wherein at least one service alert of the one or more service alerts is transmitted to at least one third-party entity, and wherein the least one third-party entity alerts other drivers of any hazardous conditions associated with the vehicle.

15. A computer-implemented method for providing vehicle demos and conversations with product experts, the method comprising:
capturing data associated with operations of the vehicle using a plurality of system sensors;
detecting a service trigger event based on the data that is captured;
identifying one or more vehicle components associated with the service trigger event;
estimating one or more severity levels of the service trigger event based on the one or more vehicle components that are identified; and
transmitting one or more service alerts to one or more target recipients based on the one or more severity levels for each vehicle component of the one or more vehicle components that is identified in response to at least one severity level of the one or more severity levels meeting a predetermined severity threshold.

16. The method of claim 15, wherein the data is associated with operations comprises tire data.

17. The method of claim 15, wherein the data is associated with operations comprises engine data.

18. The method of claim 15, further comprising modifying the one or more service alerts for each target recipient of the one or more target recipients based on one or more alert policies.

19. The method of claim 15, wherein at least one service alert of the one or more service alerts is transmitted to a driver of the vehicle, and wherein the at least one service alert indicates the service trigger event, at least one vehicle component associated with the service trigger event, and a recommendation.

20. The method of claim 15, wherein at least one service alert of the one or more service alerts is transmitted to at least one service entity, and wherein the service alert indicates the service trigger event, at least one vehicle component associated with the service trigger event, and a service request.
